(19) United States
(12) Patent Application Publication
(10) Pub. No.: US 2018/0308063 A1
(43) Pub. Date: Oct. 25, 2018

(54) Personnel Management System and Method Using Distributed Beacons

(71) Applicant: NOVAtime Technology Inc., Rancho Cucamonga, CA (US)

(72) Inventors: Joyce Jan, Rancho Cucamonga, CA (US); Frank Su, Rancho Cucamonga, CA (US); Cheng Sheng Chen, Rancho Cucamonga, CA (US); Ting Chuang, Rancho Cucamonga, CA (US)

(73) Assignee: NOVAtime Technology Inc., Rancho Cucamonga, CA (US)

(21) Appl. No.: 15/956,557

(22) Filed: Apr. 18, 2018

Related U.S. Application Data
(60) Provisional application No. 62/487,458, filed on Apr. 19, 2017.

(51) Int. Cl. G06Q 10/10; G07C 9/00; G07C 1/10; G01C 21/20

(52) U.S. Cl. CPC G06Q 10/1091; G07C 9/00087; G06Q 10/06311; G01C 21/206; G07C 1/10

(57) ABSTRACT

A personnel management system and method is disclosed. The personnel management system comprises beacons distributed around an employer facility to assist in tracking employee movement, automating punch-in and punch-out events, automating timecard record keeping, and providing navigation services within the employer facility. Detection of an employee in proximity to a particular beacon triggers a server system to log the time of the detection and update of the employee's timecard with a punch-in event, if confirmed by the employee. Similarly, detection of the employee later triggers the server system to log the time of the detection and update of the employee's timecard with a punch-out event. In some embodiments, the beacons interact with employee mobile phones via a BLUETOOTH protocol. Automation of these operations improves the accuracy and convenience of employee timekeeping while preventing some types of fraudulent behavior, thereby saving employers money.

### CROSS-REFERENCE TO RELATED APPLICATION

This patent application claims the benefit of U.S. Provisional Patent Application Ser. No. 62/487,458, entitled “Personnel Management System and Method Using Distributed Beacons,” filed Apr. 19, 2017, which is incorporated in its entirety herein by this reference.

### TECHNICAL FIELD

This invention relates to a personnel management system with time keeping functionality that utilizes beacons distributed around an enterprise to track employee location, work hours, and performance.

### BACKGROUND

Tracking employee location and hours worked is critical to the efficient operation of a business. Historically, employees would “punch-in” when they enter a work place, and then “punch-out” when they left for lunch and/or at the end of the day. This punch-in/punch-out approach requires each employee use a paper timecard and physically insert the timecard into a timestamp machine when leaving for lunch and/or end of day. Not only is this extremely inefficient, but it is susceptible to inaccuracy, fraud, and mismanagement. There is, therefore, a need for a personnel management system and method that automatically tracks employees' time and location without the need for timecards and timestamp machines.

### SUMMARY

The present invention is directed to providing an efficient and versatile personnel management system that automatically tracks work hours and location of employees and, in some embodiments, provides relevant notifications related to job assignments and navigation services related to job or appointment locations within a large facility.

These and other features, aspects, and advantages of the present invention will become better understood with reference to the following description and appended claims.

### BRIEF DESCRIPTION OF THE DRAWINGS

FIG. 1 shows a functional block diagram of a system for performing automatic punches using beacons, in accordance with the preferred embodiment of the present invention.

FIG. 2 shows a flowchart of the method for automatic punches using a beacon, in accordance with the preferred embodiment of the present invention.

FIG. 3 shows a user mobile communication device prompting a user to confirm a punch, in accordance with the preferred embodiment of the present invention.

FIG. 4 shows user interface with navigation through an employer facility shown in plan view, in accordance with the preferred embodiment of the present invention.

FIGS. 5A-5C show a user interface with augmented reality to assist a user in navigating through an employer facility, in accordance with the preferred embodiment of the present invention.

### DETAILED DESCRIPTION OF THE INVENTION

The detailed description set forth below in connection with the appended figures is intended as a description of presently-preferred embodiments of the invention and is not intended to represent the only forms in which the present invention may be constructed or utilized. The description sets forth the functions and the sequence of steps for constructing and/or operating the invention in connection with the illustrated embodiments. It is to be understood, however, that the same or equivalent functions and sequences may be accomplished by different embodiments that are also intended to be encompassed within the spirit and scope of the invention.

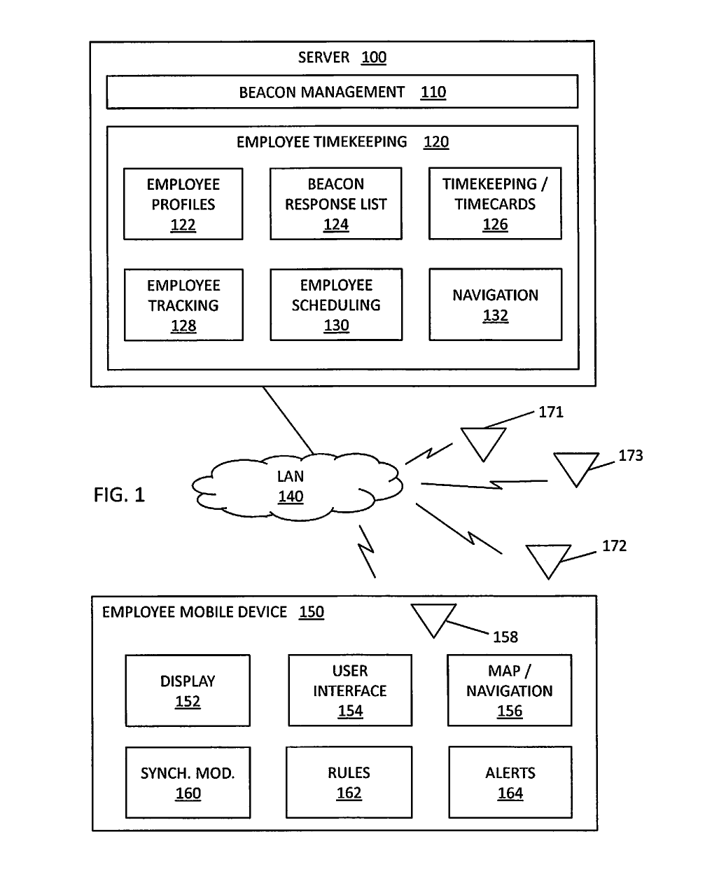

The invention in one embodiment is a personnel management system configured to automatically collect and record data pertaining to employee location and work time. Based on this data, the personnel management system may automatically generate timecards for employees as well as other relevant business documents necessary for producing payroll and billing information, for example. Referring to FIG. 1, the personnel management system comprises an enterprise server 100 operated by an employer or its administrator, a plurality of transmitter beacons 171-173 strategically installed around the employer's premises, and a plurality of mobile devices 150 carried by the employees.

In the preferred embodiment, the plurality of beacons 171-173 are low-power devices with memory and an antenna configured to transmit at 2.4 GHz in accordance with the BLUETOOTH™ protocol. In particular, each beacon is configured to transmit a unique identifier (ID) as well as data indicating the location of the beacon, if necessary. These beacons may then be installed at, for example, all entrances to the employer facility, at or near particular workrooms and work stations where employees are required to perform work activities or otherwise be present, at or near particular offices or rooms where employees may be required to work or otherwise be present, and at or near locations where employees may take breaks or eat meals.

In the preferred embodiment, the enterprise server 100 comprises a beacon management module 110 as well as an employee timekeeping module 120. The beacon management module 110 is configured to assign a unique identifier to each of the beacons 171-173 or otherwise associate a unique identifier with each of the beacons. It is this unique identifier that each beacon then transmits to the employee mobile devices when in proximity to the particular beacon.

The employee timekeeping module 120 preferably comprises a profile 122 for each employee, a beacon response list 124, and an electronic (or virtual) timecard 126 for each employee. The profile includes a variety of relevant information about the employee including the name of the employee, position and status of the employee, contact information, and payroll information related to the employee. The beacon response list 124 comprises, in some embodiments, scripts defining what actions to take in response to each beacon ID. Each time an employee makes contact with a new beacon and the beacon ID read, the ID is used to retrieve one or more actions to take in response. The actions may be unique for each combination of employee and beacon. In a preferred embodiment, these actions may include “punching-in” an employee, “punching-out” an employee, computing the time that the employee spent at that location, and automatically entering that time in the employee's timecard 126 for that day. In a preferred embodiment, the timecard 126 is an electronic file that includes a complete record of the amount of time each employee spent performing compensable actions at the employer's facility. The automated timecard keeping, in combination with other employee information—including name, social security number, work shift/schedule, salary or pay rate, exemption status, tax withholding, 401(k) and health plan deductions, and direct deposit—may be used to automatically generate payroll with little or no manual interaction.

In some embodiments, the employee timekeeping module 120 further includes an employee tracking module 128, an employee scheduling module 130, and a navigation module 132. In a preferred embodiment, the employee tracking module 128 includes a record of each employee's location during work hours based on beacon ID's. This record may be used to generate waypoints or location-based “heat” maps showing the employee's location and frequency during the course of the day. The employee scheduling module 130 includes a daily, weekly, and/or monthly schedule for each employee, which may then be used to notify an employee when that employee must leave for another location to attend a meeting, for example. The navigation module 132 may be configured to provide a map with a trajectory (or directions) to guide the employee to that meeting or other location within the employer facility. This can be especially useful for a new employee that is unfamiliar with the physical layout of the facility, and prevent the employee from entering parts of the facility that the employee is not authorized to access. Thus, an embodiment of the present invention may include geo-fencing capabilities such that if a beacon detects an employee where he or she is not authorized to be, an alarm or notification may be sent to the employer and/or management.

Each employee also carries a mobile device configured to read the beacon ID and take appropriate actions. In a preferred embodiment, the mobile device is a mobile phone 150 configured with a BLUETOOTH™ transceiver 158 and mobile software application (APP) configured to interact with the server 100. The mobile phone 150 comprises a display 152 and a user interface 154, which may include a keyboard, microphone, and speaker. The display 152 may be configured to load and guide the user to particular locations in the employer facility using maps 156, arrows, distance indicators, a compass, and/or other navigational tools.

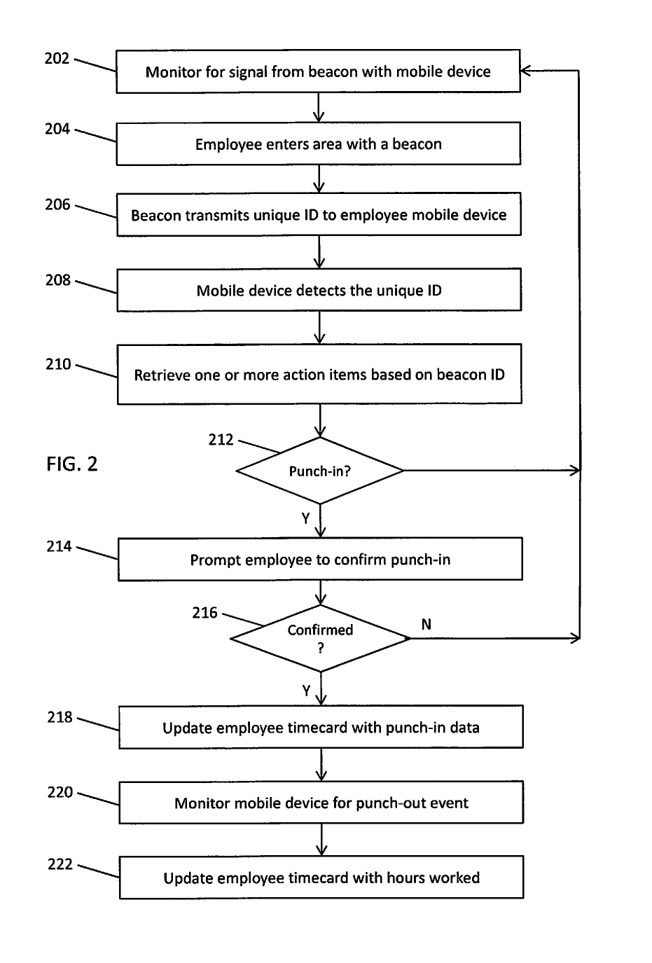

Illustrated in FIG. 2 is a flowchart of the method by which the personnel management system automatically generates an entry on an employee timecard in accordance with the preferred embodiment of the present invention. When an employ or other user is present at the employer facility and has his or her mobile device app running, the mobile device is configured to monitor 202 the transceiver 158 for transmissions from the beacons 171-173. When the employee enters an area 204 in proximity to a beacon, the beacon detects the employee's device and the mobile device detects the beacon. The beacon transmits 206 its unique ID via BLUETOOTH to said employee's mobile device. The app running on the employee's mobile device may also transmit an employee ID to the beacon or directly to the server 100. The beacon ID 208 and/or an employee ID is then used to retrieve 210 the appropriate action to take as defined in the beacon response list 124 discussed above, or by using a local copy of the employee's individual beacon response list stored on the mobile device 150.

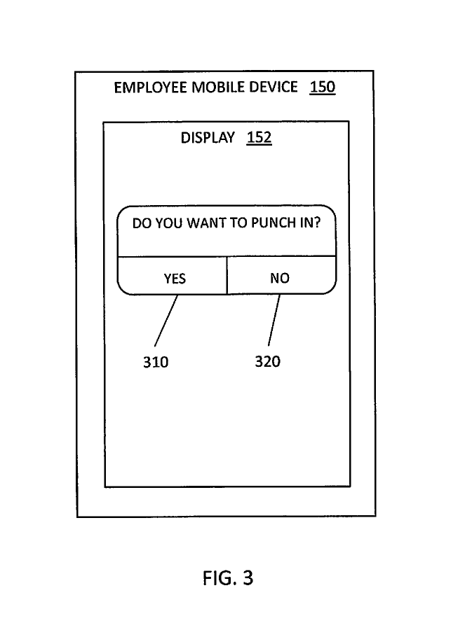

There are many actions that can be taken in response to detection of a beacon ID. For example, the server may automatically log the employee's location to effectively “punch-in” the employee for work. If the predefined action is to “punch-in” the employee, decision block 212 is answered in the affirmative and the current time entered on the employee's timecard. To be sure, the employee may be presented 214 with a button on his or her mobile device to confirm that the employee agrees to the “punch-in” at the location for that work purpose. The notification is presented on the mobile device display 152, for example. Referring to the mobile phone user interface shown in FIG. 3, if the user presses a button 310 to confirm the timekeeping operation, then decision block 216 is answered in the affirmative and the current time used to update 218 the employee's electronic timecard maintained on the server 100. However, if the user presses button 320 to decline the “punch-in”, the mobile device returns a state of monitoring for beacon signals.

Assuming the user has confirmed the “punch-in” event, the personnel management system monitors for a corresponding “punch-out” event. Any of a number of events may qualify as a “punch-out” event including (1) if the user leaves the area corresponding to the beacon that prompted the same “punch-in” event, (2) if the employee exits the employer facility, or (3) if the employee has been at the employer facility for a full eight hours or other predetermined period of time. In the first case listed above, the “punch-out” event may be detected 220 and confirmed by the user in the same manner as the “punch-in” event discussed above. Thereafter, the server timekeeping module 126 may automatically update 222 the employee's timecard to reflect the number of hours based on the punch-in and punch-out events.

In a preferred embodiment, the “punch-in” and “punch-out” events are only two of numerous actions that may be taken in response to detection of a particular beacon ID by a particular employee mobile device. Thus, the present invention is not limited to these two scenarios.

In the embodiment described above, the “punch-in” and “punch-out” events are performed automatically with or without confirmation from the employee. In other embodiments, automatic “punch-in” and “punch-out” may be implemented for limited periods of time, and manual “punch-in” and “punch-out” required outside those limited time periods. For example, automatic “punch-in” may be implemented during a punch-in window beginning, for example, one hour before and ending two hours after the employee is schedule to start work. Similarly, automatic “punch-out” may be implemented during a punch-out window beginning one hour before and ending two hours after the employee is scheduled to end work. By way of an example, an employee scheduled to work from 8 a.m. to 5 p.m. may be automatically punched-in between 7 a.m. and 10 a.m., and automatically punched-out between 4 p.m. and 7 p.m. when a beacon 171-173 is contacted. Outside the punch-in and punch-out windows, the employee may be required to either manually confirm a punch-in/punch-out event or required to manually initiate a punch-in/punch-out event via the app on their mobile communication device 150. As one skilled in the art will appreciate, the start and end times of the punch-in and punch-out windows may be based on pre-determined time periods selected by the employer and entered via a configuration setup routine at the server 100.

In some embodiments, the personnel management system is configured to generate alerts for employees based on the automatic punch-ins and punch-outs. For example, a “lunch-out” alert and “lunch-in” alert may be automatically generated for the employee based on the actual punch-in time observed. If the employee is automatically punched-in at 8:05 a.m., the personnel management system may add four hours and determine the lunch-out time to be 12:05 p.m. This lunch-out alert may be transmitted to the employee and confirmed via a confirmation button on the user's mobile phone. Like the lunch-out message, the personnel management system may compute and transmit a “lunch-in” alert notifying the employee to return to work after a 30 minute or 60 minute lunch period, for example. Alerts may be used to notify the employee of mandatory rest breaks as well.

In some embodiments, the personnel management system is configured to send alerts to employees to notify them that they need to attend a meeting or be at another location at the facility at a certain time. In that case, the personnel management system may transmit the meeting alert to the employee far enough in advance of the meeting to permit the employee enough time to walk or commute from the employee's current location to the location of the meeting. The personnel management system may even produce a map with turn-by-turn instructions to guide the employee to the intended destination using the most efficient route possible through the employer facility. The turn-by-turn instructions may be generated for indoor facilities using the beacons 171-173, generated for outdoor facilities using global positioning satellite (GPS) technology, or a combination of both.

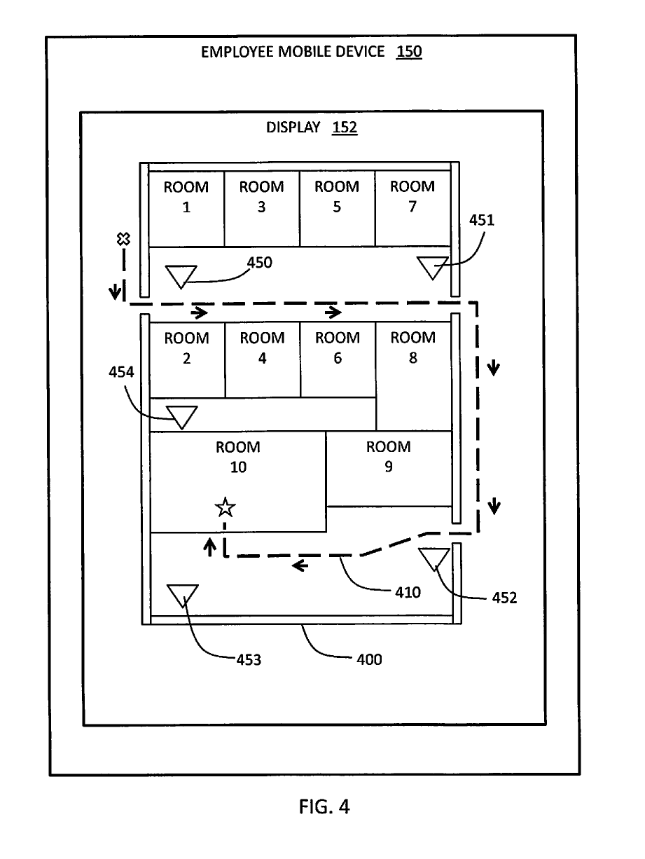

Illustrated in FIG. 4 is a diagrammatic illustration of indoor “way finding” using beacons and a diagram of the employer facility in plan view. In the preferred embodiment, the same beacons used to automatically punch-in and punch-out employees may also be used to assist those employees in navigating the employer facility. The application running on the employee mobile phone 150 is used to present a display 152 with a map or floor plan 400 of the employer facility including offices or rooms 1-10 and hallways, for example. As shown, the beacons 450-454 are distributed around the facility, primarily at the entrances to buildings. Based on the distribution of the beacons, the server 100 can track the location of the employee at all times and guide the employee from his current location to the location of a meeting, for example. Here, the navigation path 410 and corresponding arrows are guiding the employee from outside the building near room 1 to a meeting in room 10. The beacons, therefore, may be utilized to serve additional purposes beyond automatic punch-in and punch-out.

In a preferred embodiment, the plurality of beacons 450-454 are distributed about an employer facility for the purposes of monitoring/assisting employees. In other embodiments, the management system of the present invention may be employed to monitor/assist customers to navigate through retail facilities, museums, and campuses, for example.

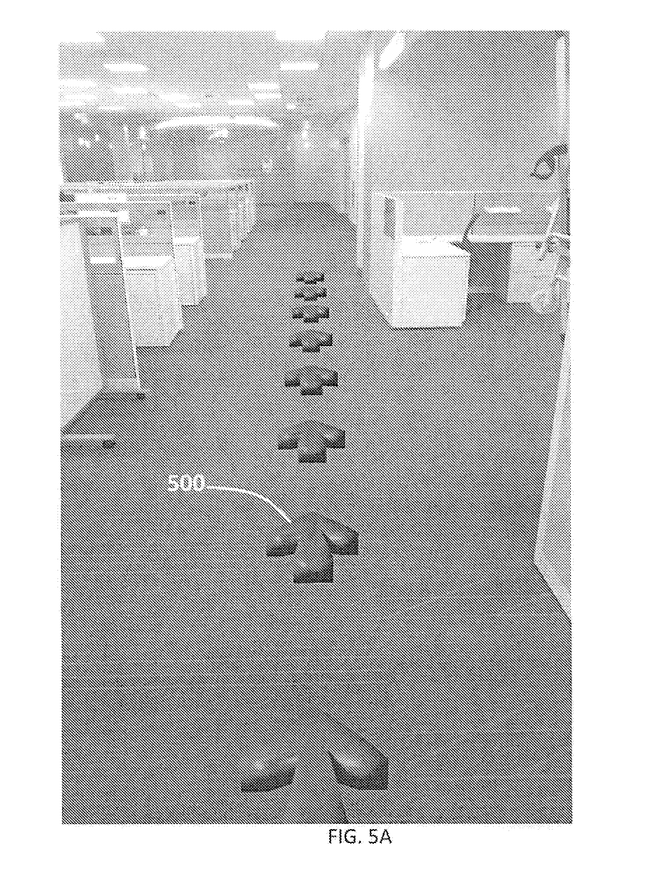

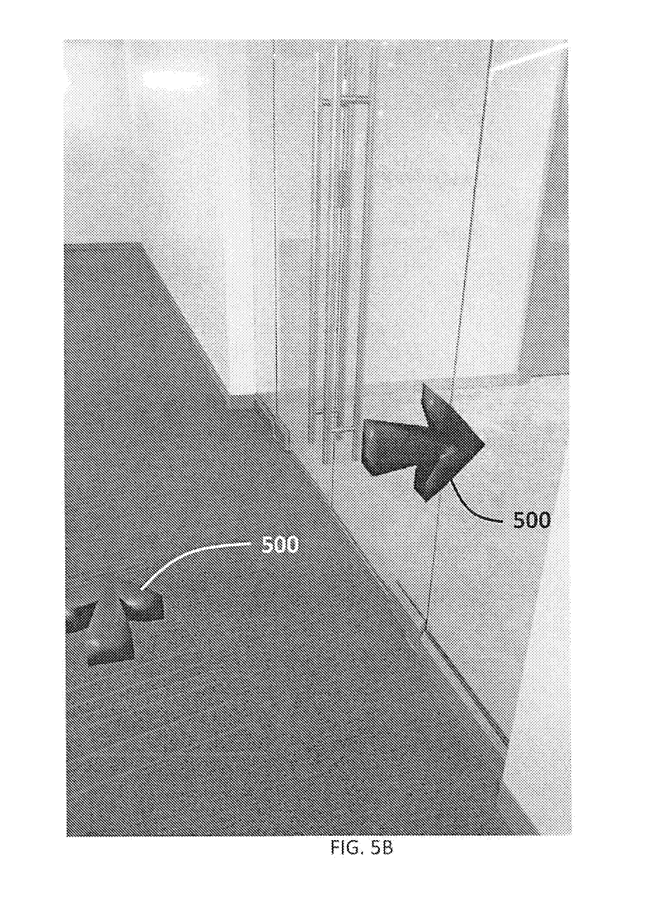

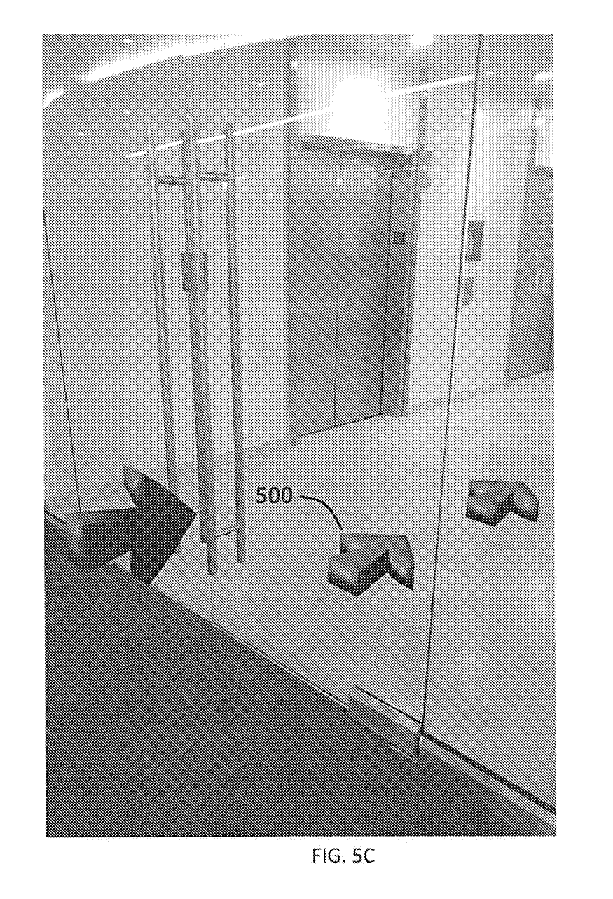

Illustrated in FIGS. 5A-5B are diagrammatic illustrations of indoor “way finding” using beacons and augmented reality. In this embodiment, augmented reality is used to superimpose navigation arrows 500 on top of actual images and/or video of the employer's facility, namely hallways (FIG. 5A), doorways (FIG. 5B), and common areas (FIG. 5C), for example. The navigation arrows 500 guide the user over a continuous path from the employee's starting point to a predetermined destination. The endpoint may be a meeting room or person, for example, determined by the server 100 based on the employee's schedule or calendar. As stated, above, the actually location of the employee may be determined from the beacons 450-454, the path determined by the navigation module 132, and the arrows added to images of the facility to guide the employee to the destination using the most efficient route while avoiding restricted areas for which the employee is not authorized to be present.

In the preferred embodiment, the personnel management system further includes wall-mounted time clocks for punch-in and punch-out events. The wall-mounted units may include scanners for reading employee badges, cameras for recognizing employees using facial recognition, and fingerprint scanners, for example. These wall-mounted time clocks may be synchronized with the server 100 to enable employees the option of manually punching the clock at some entrances while enabling automatic punch-in at other entrances, thereby providing maximal versatility.

The server 100 and mobile communication device 150 may be implement using any or all of the systems and apparatus discussed herein, including personal computers, tablet computers, hand-held devices, cellular telephones, servers, database, cloud-computing environments, and components thereof.

One skilled in the art will recognize that an implementation of an actual computer or computer system may have other structures and may contain other components as well, and that FIG. 1 is a high level representation of some of the components of such a computer for illustrative purposes.

The system can take the form of substantially a hardware embodiment, substantially a software embodiment or an embodiment containing both hardware and software elements. To the extent the system is implemented in software, such software includes but is not limited to firmware, resident software, microcode, etc.

Furthermore, the system can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium comprise a semiconductor or solid-state memory, magnetic tape, a removable computer diskette, a random access memory (RAM), a read-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code comprises at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Described above, aspects of the present application are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. The internet can include a plurality of local area networks (“LANs”) and a wide area network (“WAN”) that are interconnected by routers. The routers are special purpose computers used to interface one LAN or WAN to another. Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art.

Furthermore, computers and other related electronic devices can be remotely connected to either the LANs or the WAN via a digital communications device, modem and temporary telephone, or a wireless link. It will be appreciated that the internet comprises a vast number of such interconnected networks, computers, and routers.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HTML, or other markup languages, that are electronically stored at or dynamically generated by “WWW sites” or “Web sites” throughout the Internet. Additionally, client-side software programs that communicate over the Web using the TCP/IP protocol are part of the WWW, such as JAVA® applets, instant messaging, e-mail, browser plug-ins, Macromedia Flash, chat and others. Other interactive hypertext environments may include proprietary environments such as those provided in America Online or other online service providers, as well as the “wireless Web” provided by various wireless networking providers, especially those in the cellular phone industry. It will be appreciated that the present application could apply in any such interactive communication environments, however, for purposes of discussion, the Web is used as an exemplary interactive hypertext environment with regard to the present application.

A website is a server/computer connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a website elsewhere on the Internet. Each hyperlink is assigned a URL that provides the name of the linked document on a server connected to the Internet. Thus, whenever a hypertext document is retrieved from any web server, the document is considered retrieved from the World Wide Web. Known to those skilled in the art, a web server may also include facilities for storing and transmitting application programs, such as application programs written in the JAVA® programming language from Sun Microsystems, for execution on a remote computer. Likewise, a web server may also include facilities for executing scripts and other application programs on the web server itself.

A remote access user may retrieve hypertext documents from the World Wide Web via a web browser program. A web browser, such as Netscape's NAVIGATOR® or Microsoft's Internet Explorer, is a software application program for providing a user interface to the WWW. Upon request from the remote access user via the web browser, the web browser requests the desired hypertext document from the appropriate web server using the URL for the document and the hypertext transport protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JAVA applets, for execution on the client computer. Finally, the WWW browser may include optional software components, called plug-ins, that run specialized functionality within the browser.

The foregoing description of the preferred embodiments of the invention and the details regarding the invention, and FIGS. 1-4, appended hereto, have been presented for the purposes of illustration and description, and are not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A system for managing time and attendance of a plurality of employees, each employee having a mobile communication device, the system comprising:
at least one beacon configured to transmit a wireless signal comprising a beacon identifier;
a server configured to:
maintain an electronic timecard associated with each of the plurality of employees; and
assign a unique employee identifier associated with each of the plurality of employees; and
wherein the mobile communication device associated with each of the plurality of employees is configured to:
store the employee identifier associated with one of the plurality of employees;
detect the wireless signal from the at least one beacon;
detect the beacon identifier from the wireless signal when in proximity to the beacon;
retrieve a punch event based on the beacon identifier; and
transmit the punch event, employee identifier, and timestamp to the server;
wherein the server is further configured to:
receive the punch event, employee identifier, and timestamp; and
update the electronic timecard associated with one of the plurality of employees based on the punch event, employee identifier, and timestamp.

2. The system of claim 1, wherein the punch event is selected from the group consisting of: punch-in event and punch-out event.

3. The system of claim 2, wherein the server is further configured to:
identify a punch-in event based on a punch-in window comprising a punch-in start time and punch-in finish time; and
identify a punch-out event based on a punch-out window comprising a punch-out start time and punch-out finish time.

4. The system of claim 2, wherein server is further configured to update to the electronic timecard with hours worked based on the punch-in event and punch-out-event.

5. The system of claim 4, wherein server is further configured to generate payroll based on the hours worked.

6. The system of claim 3, wherein server is further configured to:
transmit a lunch-out alert to an employee based on a punch-in start time; and
transmit a lunch-in alert to an employee based on a punch-in start time.

7. The system of claim 4, wherein server is further configured to generate payroll based on the hours worked.

8. The system of claim 1, wherein the server is configured to transmit a meeting alert to an employee instructing the employee to be at a particular location at a particular time.

9. The system of claim 8, wherein the server is configured to transmit to the mobile communication device associated with each of the plurality of employees a map of the employer facility with a navigation line indicating a path between a current location of an employee and a location of a meeting to be attended by the employee.

10. A method for managing time and attendance of a plurality of employees, each employee having a mobile communication device, the method comprising:
monitoring for a signal from one or a plurality of beacons with a mobile communication device;
receiving a beacon identifier from one of the plurality of beacons;
retrieving, based on the beacon identifier, a punch-in event;
confirming, with an employee, whether to punch-in the employee on an electronic timecard associated with the employee;
if confirmed by the employee, automatically punching-in the employee on the electronic timecard associated with the employee;
receiving a beacon identifier from one of the plurality of beacons after the automatic punch-in of the employee on the electronic timecard associated with the employee;
retrieving, based on the beacon identifier, a punch-out event;
confirming, with an employee, whether to punch-out the employee on the electronic timecard associated with the employee;
if confirmed by the employee, automatically punching-out the employee on the electronic timecard associated with the employee.

11. The method of claim 10, further comprising:
automatically updating the electronic timecard associated with the employee based on the punch-in event and punch-out event.

12. The method of claim 11, further comprising:
automatically updating the electronic timecard associated with the employee based on the lunch-in event and lunch-out event.

13. The method of claim 12, wherein automatically updating the electronic timecard associated with the employee comprises:
determining hours worked by the employee based on a time associated with the punch-in event, punch-out event, lunch-in event, and lunch-out event.

14. The method of claim 13, further comprising:
generating payroll based on the electronic timecard associated with the employee.

15. The method of claim 14, further comprising:
transmitting a meeting alert to an employee instructing the employee to be at a particular location at a particular time.

16. The method of claim 15, further comprising:
transmitting a map of the employer facility with a navigation line indicating a path between a current location of an employee and a location of a meeting to be attended by the employee.

17. The method of claim 10, wherein the step of automatically punching-in the employee is limited to a predetermined punch-in window.

18. The method of claim 17, wherein the step of automatically punching-out the employee is limited to a predetermined punch-out window.
